(19) United States
(12) Patent Application Publication
(10) Pub. No.: US 2021/0005955 A1
(43) Pub. Date: Jan. 7, 2021

(54) ANTENNA MODULE AND COMMUNICATION APPARATUS EQUIPPED WITH THE SAME

(71) Applicant: Murata Manufacturing Co., Ltd., Kyoto (JP)

(72) Inventors: Kaoru SUDO, Kyoto (JP); Yoshiki YAMADA, Kyoto (JP); Ryo KOMURA, Kyoto (JP)

(21) Appl. No.: 17/023,783

(22) Filed: Sep. 17, 2020

Related U.S. Application Data
(63) Continuation of application No. PCT/JP2019/051190, filed on Dec. 26, 2019.

(30) Foreign Application Priority Data
Jan. 25, 2019 (JP) 2019-011251

(51) Int. Cl. H01Q 1/24; H01Q 9/04; H01Q 21/06; G16Y 10/75; H01Q 21/24

(52) U.S. Cl. CPC H01Q 1/243; H01Q 9/0421; H01Q 21/24; G16Y 10/75; H01Q 21/065

(57) ABSTRACT

An antenna module includes a dielectric substrate, a plurality of antenna elements, a ground electrode (GND), and a conductor wall. The plurality of antenna elements is arranged in the dielectric substrate in an array form in a first direction and a second direction. The ground electrode (GND) is arranged on the dielectric substrate so as to face the plurality of antenna elements. For each antenna element included in the plurality of antenna elements, the conductor wall is arranged along the second direction between the antenna elements adjacent in the first direction but no conductor wall is arranged between the antenna elements adjacent in the second direction. The second direction is a polarization direction of a radio wave radiated from each of the plurality of antenna elements.

This is a continuation of International Application No. PCT/JP2019/051190 filed on Dec. 26, 2019 which claims priority from Japanese Patent Application No. 2019-011251 filed on Jan. 25, 2019. The contents of these applications are incorporated herein by reference in their entireties.

### BACKGROUND

### Technical Field

The present disclosure relates to an antenna module and a communication apparatus equipped with the same, and more particularly, to a technique for improving antenna characteristics when beamforming is performed in an antenna array.

Japanese Unexamined Patent Application Publication No. 2008-5164 (Patent Document 1) discloses a composite antenna array device in which a plurality of array antennas is arrayed on the same dielectric substrate. In the antenna device of Patent Document 1, it is possible to change the directivities of radio waves radiated from the respective antenna arrays by giving phase difference to feed phases of radio frequency signals that are supplied to the respective antenna arrays.
Patent Document 1: Japanese Unexamined Patent Application Publication No. 2008-5164

### BRIEF SUMMARY

In recent years, mobile terminals, such as smart phones have spread, and in addition, household appliances and electronic apparatuses having wireless communication functions have been increasing with technological innovation, such as IoT. Accordingly, there is a concern that communication traffic of a wireless network increases to lower communication speed and communication quality.

As one measure for solving, such a problem, development of the fifth generation mobile communication system (5G) has been progressing. In the 5G, advanced beamforming and spatial multiplexing are performed using a plurality of antenna elements, and a millimeter wave band signal of a higher frequency (several tens of GHz) is used in addition to a 6 GHz-band frequency signal, which has been used in the existing technique, so that increase in the communication speed and improvement in the communication quality are aimed to be achieved.

In an antenna array in which the plurality of antenna elements is two-dimensionally arrayed, when a beam is inclined in a polarization direction (electric field direction) of a radio wave in the beamforming for changing the directivity of the radiated radio wave, an antenna gain may be decreased at a specific inclination angle.

The present disclosure improves antenna characteristics when beamforming is performed in an antenna array having a plurality of antenna elements.

An antenna module according to the present disclosure includes a dielectric substrate, a plurality of antenna elements, a ground electrode, and a conductor wall. The plurality of antenna elements is arranged in an array form in a first direction and a second direction in the dielectric substrate. The ground electrode is arranged on the dielectric substrate so as to face the plurality of antenna elements. For each antenna element included in the plurality of antenna elements, the conductor wall is arranged along the second direction between the antenna elements adjacent in the first direction whereas no conductor wall is arranged between the antenna elements adjacent in the second direction. The second direction is a polarization direction of a radio wave radiated from each of the plurality of antenna elements.

According to the present disclosure, in an antenna array having a plurality of antenna elements, it is possible to improve antenna characteristics when beamforming is performed.

### BRIEF DESCRIPTION OF THE SEVERAL VIEWS OF THE DRAWINGS

FIG. 1 is a block diagram of a communication apparatus to which an antenna module according to Embodiment 1 is applied.

FIG. 2A is a plan view and FIG. 2B is a cross-sectional view of the antenna module according to Embodiment 1.

FIG. 3 is a perspective view of the antenna module of FIGS. 2A and 2B.

FIG. 4 is a plan view of an antenna module of Comparative Example 1.

FIG. 5 is a plan view of an antenna module of Comparative Example 2.

FIG. 6 is a graph for explaining an antenna gain when a beam is inclined in an electric field direction in each of the antenna modules of Embodiment 1 and Comparative Examples.

FIGS. 7A, 7B, and 7C are diagrams illustrating distribution of a current flowing through a ground electrode when 0=45° in each of the antenna modules of Embodiment 1 and Comparative Examples.

FIG. 8 is a plan view of an antenna module according to Embodiment 2.

FIG. 9 is a plan view of an antenna module according to Embodiment 3.

FIG. 10 is a perspective view of a part of the antenna module according to Embodiment 3.

FIG. 11 is a cross-sectional view of a part of the antenna module according to Embodiment 3.

FIG. 12A is a plan view and FIG. 12B is a cross-sectional view of an antenna module according to a variation.

### DETAILED DESCRIPTION

Hereinafter, embodiments of the present disclosure will be described in detail with reference to the accompanying drawings. Note that the same or corresponding parts in the drawings are denoted by the same reference numerals, and description thereof will not be repeated.

### Embodiment 1

(Basic Configuration of Communication Apparatus)

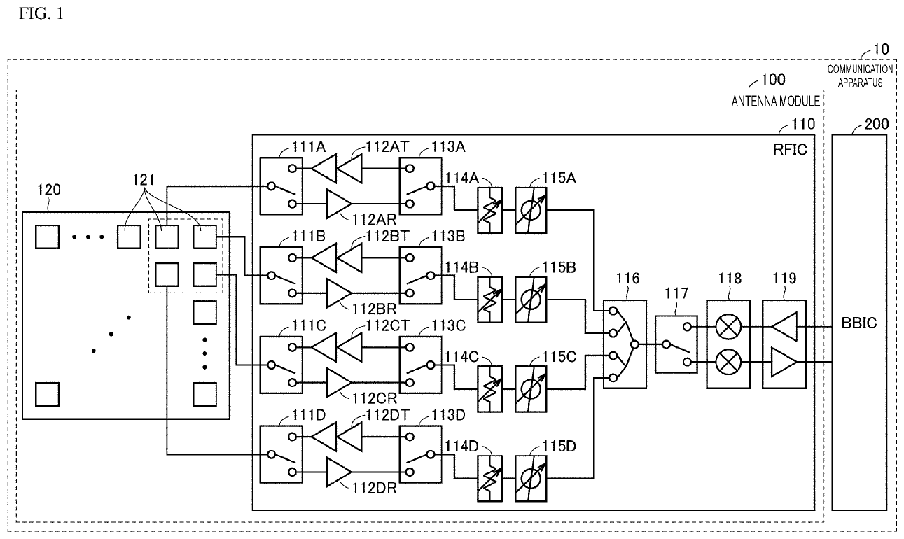

FIG. 1 is an example of a block diagram of a communication apparatus 10 to which an antenna module 100 according to the embodiment is applied. The communication apparatus 10 is, for example, a mobile terminal, such as a smart phone and a tablet. Frequency bands of radio waves that are used for the antenna module 100 according to the embodiment are millimeter wave bands having center frequencies of, for example, 28 GHz, 39 GHz, and 60 GHz. However, radio waves in a frequency band other than those described above are also applicable.

Referring to FIG. 1, the communication apparatus 10 includes the antenna module 100 and a BBIC 200 configuring a baseband signal processing circuit. The antenna module 100 includes an RFIC 110, which is an example of a feed circuit, and an antenna device 120. The communication apparatus 10 upconverts, into a radio frequency signal, a signal transmitted from the BBIC 200 to the antenna module 100 and radiates the signal from the antenna device 120, and downconverts a radio frequency signal received by the antenna device 120 and processes the signal in the BBIC 200.

In FIG. 1, for ease of explanation, only configurations corresponding to four antenna elements 121 among a plurality of antenna elements 121 configuring the antenna device 120 are illustrated, and configurations corresponding to the other antenna elements 121 having the same configurations are omitted. In the antenna device 120, the plurality of antenna elements 121 is arranged in a two-dimensional array form. In the embodiment, each antenna element 121 is a patch antenna having a substantially square flat plate shape.

The RFIC 110 includes switches 111A to 111D, 113A to 113D, and 117, power amplifiers 112AT to 112DT, low noise amplifiers 112AR to 112DR, attenuators 114A to 114D, phase shifters 115A to 115D, a signal multiplexer/demultiplexer 116, a mixer 118, and an amplification circuit 119.

When a radio frequency signal is transmitted, the switches 111A to 111D and 113A to 113D are switched to be connected to the power amplifiers 112AT to 112DT, and the switch 117 is connected to a transmission-side amplifier of the amplification circuit 119. When the radio frequency signal is received, the switches 111A to 111D and 113A to 113D are switched to be connected to the low-noise amplifiers 112AR to 112DR, and the switch 117 is connected to a reception-side amplifier of the amplification circuit 119.

A signal transmitted from the BBIC 200 is amplified by the amplification circuit 119 and is upconverted by the mixer 118. The transmission signal, which is an up-converted radio frequency signal, is branched into four by the signal multiplexer/demultiplexer 116, passes through four signal paths, and is fed to the different antenna elements 121. In this case, the directivity of the antenna device 120 can be adjusted (beamformed) by individually adjusting the phase shift degrees of the phase shifters 115A to 115D arranged in the respective signal paths.

The reception signals that are radio frequency signals received by the respective antenna elements 121 pass through the different four signal paths and are multiplexed by the signal multiplexer/demultiplexer 116. The synthesized received signal is down-converted by the mixer 118, amplified by the amplification circuit 119, and transmitted to the BBIC 200.

The RFIC 110 is formed as, for example, a one-chip integrated circuit component including the above-described circuit configuration. Alternatively, the devices (switches, power amplifiers, low-noise amplifiers, attenuators, and phase shifters) in the RFIC 110, which correspond to the respective antenna elements 121, may be formed as one-chip integrated circuit components for the respective corresponding antenna elements 121.

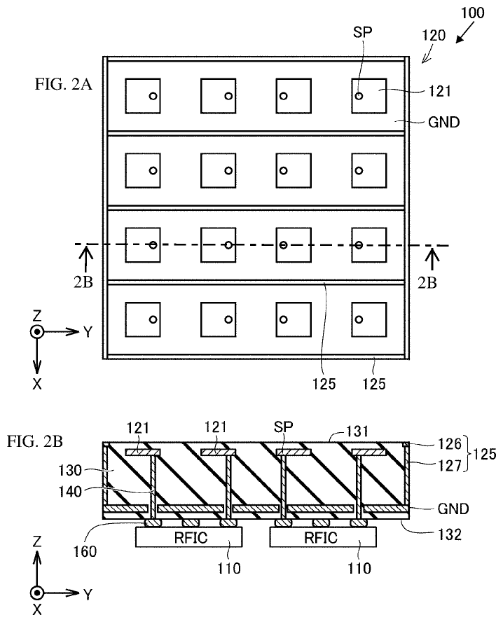

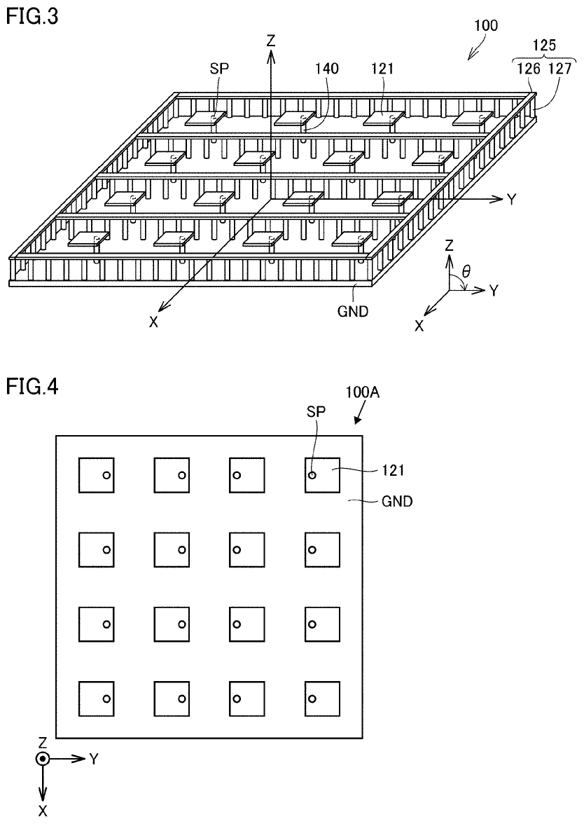

(Configuration of Antenna Module) FIGS. 2 and 3 are diagrams for explaining the details of the configuration of the antenna module 100 according to Embodiment 1. FIG. 2A above is a plan view of the antenna module 100, and FIG. 2B below is a cross-sectional view. FIG. 3 is a perspective view of the antenna module 100.

Referring to FIGS. 2 and 3, the antenna module 100 includes, in addition to the antenna elements 121 and the RFIC 110, a dielectric substrate 130, feed wirings 140, a ground electrode GND, and a conductor wall 125. In FIGS. 2A and 3, the dielectric substrate 130 is omitted in order to make the internal configuration easy to view. In the following description, the positive direction of a Z axis in each drawing is referred to as an upper surface side whereas the negative direction thereof is referred to as a lower surface side in some cases.

The dielectric substrate 130 is formed of, for example, a low temperature co-fired ceramics (LTCC) multilayer substrate, a multilayer resin substrate formed by laminating a plurality of resin layers made of resin, such as epoxy and polyimide, a multilayer resin substrate formed by laminating a plurality of resin layers made of a liquid crystal polymer (LCP) having a lower dielectric constant, a multilayer resin substrate formed by laminating a plurality of resin layers made of fluorine-based resin, or a ceramic multilayer substrate other than the LTCC. Note that the dielectric substrate 130 is not limited to the multilayer substrate and may be a substrate having a single-layer structure.

The dielectric substrate 130 has a rectangular planar shape, and the plurality of substantially square antenna elements 121 is arranged in the array form along the X-axis direction (first direction) and the Y-axis direction (second direction) on an inner layer of the dielectric substrate 130 or a surface 131 thereof on the upper surface side. In the dielectric substrate 130, the ground electrode GND is arranged so as to face the antenna elements 121 on a layer on the lower surface side of the antenna elements 121. Further, the RFIC 110 is arranged on a back surface 132 of the dielectric substrate 130 on the lower surface side with solder bumps 160 interposed therebetween.

The radio frequency signal supplied from the RFIC 110 is transmitted to feed points SP of the respective antenna elements 121 after passing through the feed wirings 140 penetrating through the ground electrode GND. The feed wiring 140 is formed by a via that penetrates through the layers of the dielectric substrate 130 and a wiring pattern that is arranged in the layer.

The feed points SP are arranged at positions offset in the Y-axis direction of FIGS. 2A and 2B from the centers (intersections of diagonal lines) of the antenna elements 121. When the radio frequency signal is supplied to each of the feed points SP, radio waves whose polarization directions are the Y-axis direction are radiated from the antenna elements 121. In the example of FIGS. 2A and 2B, for the antenna elements 121 of the left half, the feed points SP are arranged at positions offset from the centers of the antenna elements 121 in the positive Y-axis direction, and for the antenna elements 121 of the right half, the feed points SP are arranged at positions offset from the centers of the antenna elements 121 in the negative Y-axis direction. For example, when the radio waves are radiated in the positive Z-axis direction, the phases of all the antenna elements 121 are made to coincide with one another by supplying, to the antenna elements 121 of the right half, radio frequency signals having phases opposite to those of signals that are supplied to the antenna elements 121 of the left half. As described above, by symmetrically arranging the antenna elements 121 of the left half and the antenna elements 121 of the right half, it is possible to secure the symmetry of the antenna module as a whole.

In the antenna device 120, the conductor wall 125 is formed so as to surround the entirety of the plurality of antenna elements 121. The conductor wall 125 is also formed along the Y-axis direction between the antenna elements adjacent in the X-axis direction. Note that no conductor wall 125 is formed between the antenna elements adjacent in the Y-axis direction. As will be described later, the conductor wall 125 has a function of interrupting a current flowing through the ground electrode GND.

The conductor wall 125 is linearly arranged along the X axis or the Y axis. The conductor wall 125 is formed of a plurality of vias 127 connected to the ground electrode GND and a wiring pattern 126 that connects the vias 127. Note that the linearly-arranged vias 127 may be plate-shaped members. The height of the conductor wall 125 from the ground electrode GND in the Z-axis direction can be set to be lower than the antenna elements 121 from the ground electrode GND. In the example of FIGS. 2A and 2B, the height of the conductor wall 125 is set to substantially the same as that of the antenna elements 121.

The vias 127 forming the conductor wall 125 are not limited to be formed as vias that extend linearly in the Z-axis direction as illustrated in FIGS. 2 and 3. For example, in the case where the dielectric substrate 130 is formed of the multilayer substrate, a slight level difference may be provided in the vias between each of the layers. Alternatively, the vias may be formed in a stepwise or zigzag shape in the Z-axis direction by partially using a wiring pattern.

In FIGS. 2 and 3, conductors forming the antenna elements, the electrodes, the wiring patterns, the vias, and the like are made of aluminum (Al), copper (Cu), gold (Au), silver (Ag), or metal containing an alloy thereof as a main component.

In the antenna array in which the plurality of antenna elements is arranged in an array form, it is possible to incline the radiation direction of the radio waves (beams) radiated from the antenna array and adjust the directivity thereof by adjusting the phases of the radio frequency signals that are supplied to the antenna elements. For example, it is possible to radiate radio waves to communication terminals in a wide range by performing beamforming as described above in an antenna at a base station of a communication system.

When the beam is inclined in the polarization direction (electric field direction: azimuth direction (θ)) of the radio waves in beamforming, a phenomenon that an antenna gain decreases at a specific inclination angle occurs in some cases.

In Embodiment 1, by forming the above-described conductor wall between the adjacent antenna elements in the antenna array, the decrease in the antenna gain, which occurs at the specific inclination angle when the beam is inclined, can be suppressed.

FIG. 4 is a plan view of an antenna module 100A of Comparative Example 1. In the antenna module 100A, no conductor wall 125 is formed on the entire circumference of the antenna elements 121 and between the antenna elements 121. FIG. 5 is a plan view of an antenna module 100B of Comparative Example 2. In the antenna module 100B, in addition to the configuration of the antenna module 100 of Embodiment 1, the conductor wall 125 is formed also between the antenna elements adjacent in the Y-axis direction.

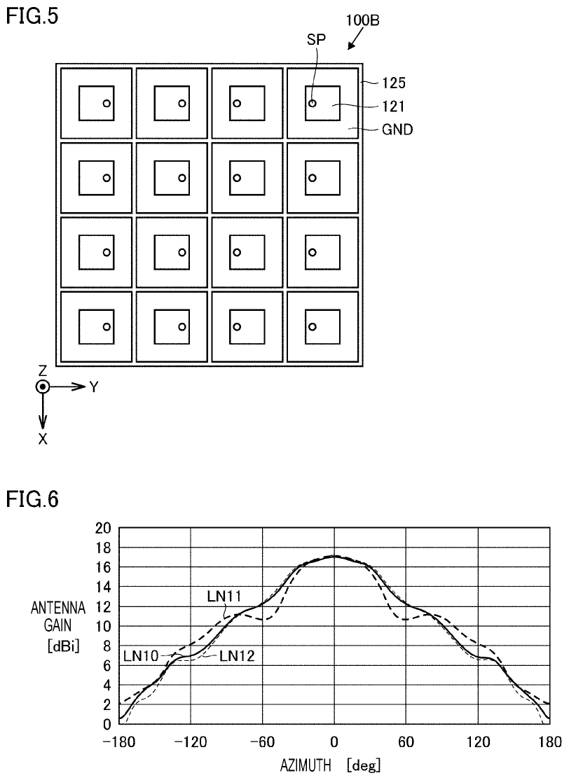

FIG. 6 is a graph for explaining the antenna gain when the beam is inclined in the electric field direction (azimuth direction) in each of the antenna modules of Embodiment 1 and Comparative Examples 1 and 2. In FIG. 6, the horizontal axis represents the inclination angle (0) in the azimuth direction, and the vertical axis represents a maximum antenna gain that can be taken in each azimuth. In FIG. 6, solid curve LN10 indicates the case of Embodiment 1 and dashed curves LN11 and LN12 indicate the cases of Comparative Examples 1 and 2, respectively. In a range in which the inclination angle in the azimuth direction is greater than 90° (and a range in which the inclination angle in the azimuth direction is less than −90°), the gain of the radio waves radiated to the back surface side of the antenna module is indicated, but the gain is obtained actually due to side lobes and a back lobe.

Referring to FIG. 6, in general, the antenna gain is the largest when the beam is not inclined (i.e., θ=0°), and it gradually decreases as an absolute value of the inclination angle increases. However, it can be seen that in Comparative Example 1 in which the conductor wall 125 is not formed (dashed curve LN11), the amount of decrease in the antenna gain is relatively large in the azimuth range of θ=45° to 75° (and θ=−75° to −45°) compared to the other angle ranges.

On the other hand, when the conductor wall 125 is formed as in Embodiment 1 and Comparative Example 2, the antenna gain in the above-described azimuth range of θ=45° to 75° (and θ=−75° to −45°) is improved by about 2 dBi to 3 dBi as compared to Comparative Example 1. In the range of −90° to 90°, which is a substantial radiation direction of the antenna module, almost the same antenna gain is realized in Embodiment 1 and Comparative Example 2. As described above, in the configuration of Embodiment 1, the conductor wall 125 along the X-axis direction (magnetic field direction) is not formed between the antenna elements. Therefore, the configuration of Embodiment 1 can improve the gain at the same degree with a simpler configuration than that of Comparative Example 2, which leads to reduction in the manufacturing cost.

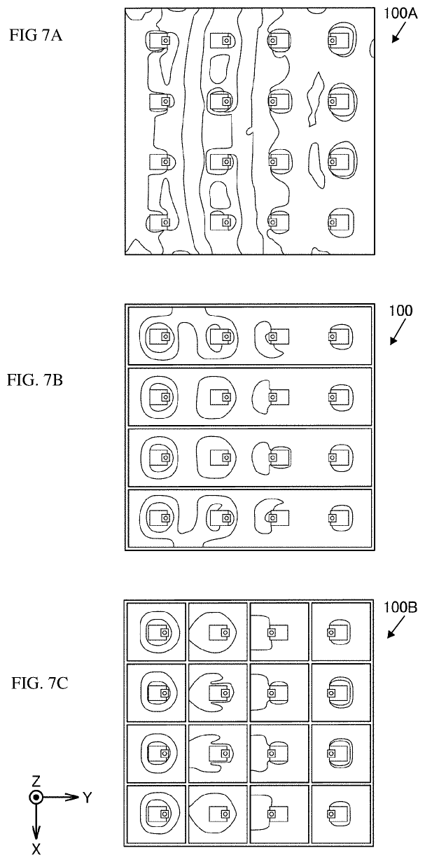

FIGS. 7A-7C are diagrams illustrating an example of distribution of a current flowing through the ground electrode GND when the beam is inclined at the azimuth angle of 45° (θ=45°) in each of the antenna modules of Embodiment 1 and Comparative Examples 1 and 2. FIG. 7A illustrates the case of the antenna module 100A of Comparative Example 1, FIG. 7B illustrates the case of the antenna module 100 of Embodiment 1, and FIG. 7C illustrates the case of the antenna module 100B of Comparative Example 2. In this case, the current flows through the ground electrode GND from the positive direction of the Y axis, which is the electric field direction, toward the negative direction thereof. In FIGS. 7A-7C, portions having the same current intensities (i.e., in-phase planes of the current) are depicted as contour lines.

Referring to FIGS. 7A-7C, in Comparative Example 1 (FIG. 7A) in which the conductor wall 125 is not formed, the adjacent antenna elements 121 influence each other. Therefore, the in-phase planes of the current are distorted, and the in-phase planes along the X axis have not linear shapes but arch shapes. Due to this, the following state is considered to be made. That is, the phases of the radio waves radiated from the antenna elements 121 arranged in central portions and the phases of the radio waves radiated from the antenna elements 121 arranged in end portions do not coincide with each other even for the antenna elements 121 arranged along the X axis, resulting in decrease in the antenna gain.

On the other hand, in Embodiment 1 (FIG. 7B) in which the conductor wall 125 is formed along the Y axis, the conductor wall 125 blocks influences by the antenna elements 121 adjacent in the X-axis direction. Therefore, the in-phase planes of the current along the X axis have substantially linear shapes. That is, it is considered that since the phases of the radio waves of the antenna elements 121 adjacent in the X-axis direction coincide with each other, decrease in the antenna gain is suppressed.

In Comparative Example 2 (FIG. 7C) in which the conductor wall 125 is formed along the X-axis direction and the Y-axis direction, since each antenna element 121 is partitioned by the conductor wall 125, the influences by the adjacent antenna elements 121 are eliminated. Therefore, it is needless to say that the in-phase planes of the current along the X-axis direction in the respective antenna elements 121 substantially coincide with one another. Accordingly, also in Comparative Example 2, decrease in the antenna gain is suppressed.

As illustrated in FIGS. 7A-7C, it is considered that the decrease in the antenna gain, which occurs when the radiation direction of the radio waves is inclined, is caused by deviation in the phase of the current along the direction (the X-axis direction) orthogonal to the electric field direction (the Y-axis direction). Therefore, the decrease in the antenna gain can be suppressed by providing the conductor wall 125 between the antenna elements 121 adjacent in the X-axis direction to eliminate mutual influences. Of course, the decrease in the antenna gain can be suppressed with the configuration of Comparative Example 2. However, it is possible to obtain an effect of improving the antenna gain, which is equivalent to that of Comparative Example 2, with a simpler configuration by forming the conductor wall 125 between the antenna elements along the electric field direction (Y-axis direction) and forming no conductor wall 125 between the antenna elements along the magnetic field direction (X-axis direction) as in Embodiment 1.

### Embodiment 2

In Embodiment 1, the configuration has been described in which the plurality of antenna elements 121 is linearly arranged in the X-axis direction and the Y-axis direction and the continuous conductor wall 125 is formed between the antenna elements 121 adjacent in the X-axis direction. However, the array of the plurality of antenna elements 121 may not be necessarily arranged linearly in each direction.

In Embodiment 2, the configuration in which the antenna elements adjacent in one direction are arranged linearly whereas the antenna elements adjacent in the other direction are arranged in a zigzag form (that is, staggered arrangement) will be described.

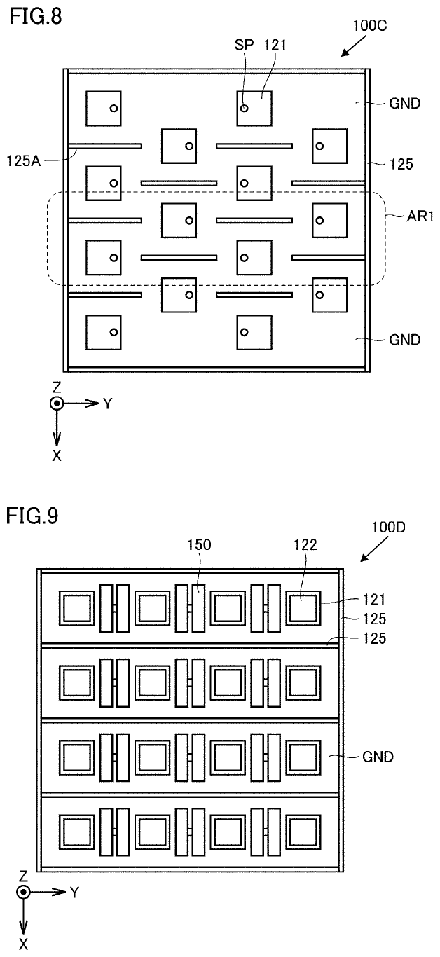

FIG. 8 is a plan view of an antenna module 100C according to Embodiment 2. In the antenna module 100C, the antenna elements adjacent in the X-axis direction (first direction) orthogonal to the electric field direction (polarization direction) are linearly arranged. The antenna elements adjacent in the Y-axis direction (second direction) along the electric field direction are arranged at positions offset from each other in the X-axis direction and are arranged in the zigzag form as indicated by a region AR1 of a dashed-line frame in FIG. 8.

Further, conductor walls 125A extending in the Y-axis direction are formed between the antenna elements adjacent in the X-axis direction.

Note that the length of each conductor wall 125A in the Y-axis direction is desirably equal to or larger than the length of the side of each antenna element 121 along the Y axis. Further, when the antenna device 120 is viewed transparently in the X-axis direction, the conductor walls 125A can be formed so as to prevent gaps from being generated between the conductor walls 125A. With this configuration, it is possible to reduce mutual influences of the antenna elements 121 adjacent in the X-axis direction and suppress decrease in the antenna gain, which occurs at a specific inclination angle when the radiation direction of the radio waves is inclined in the electric field direction.

### Embodiment 3

In Embodiment 3, the configuration in which current interruption elements are arranged between the antenna elements adjacent in the Y-axis direction in addition to the configuration in which the conductor wall along the polarization direction (Y-axis direction) is formed between the antenna elements as in Embodiment 1 will be described.

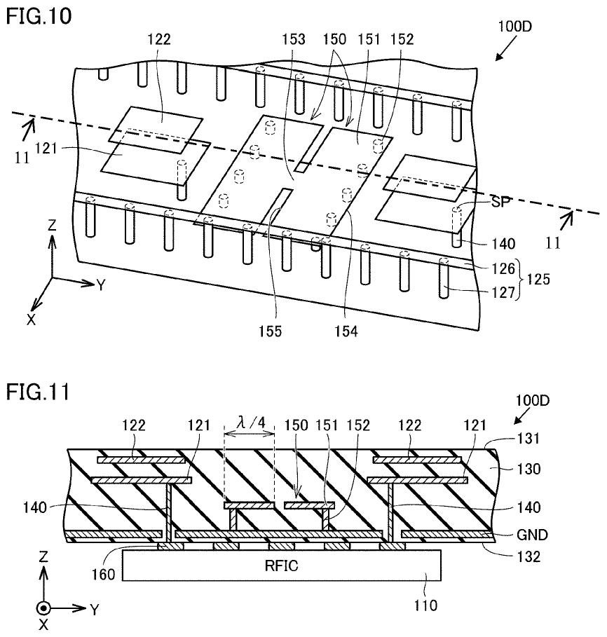

FIGS. 9 to 11 are diagrams for explaining the configuration of an antenna module 100D according to Embodiment 3. FIG. 9 is a plan view of the antenna module 100D and FIG. 10 illustrates a part of a perspective view of the antenna module 100D. FIG. 11 is a partial cross-sectional view of the vicinity of a central portion in the Y-axis direction.

Referring to FIGS. 9 to 11, in the antenna module 100D, the plurality of antenna elements 121 is linearly arranged in each of the X-axis direction and the Y-axis direction. As in the antenna module 100 of Embodiment 1, the conductor wall 125 is formed so as to surround the entirety of the antenna elements 121, and further, the conductor wall 125 is formed along the Y-axis direction between the antenna elements 121 adjacent in the X-axis direction.

The antenna module 100D is a so-called stack-type antenna in which parasitic elements 122 are provided for the respective antenna elements 121. The parasitic elements 122 are arranged in the dielectric substrate 130 at positions closer to the surface 131 side of the dielectric substrate 130 than the corresponding antenna elements 121 so as to face the antenna elements 121. The parasitic elements 122 are provided to widen the frequency band of the radio waves radiated from the antenna elements 121.

In the antenna module 100D, at least one current interruption element 150 is arranged between the antenna elements 121 adjacent in the Y-axis direction. Each current interruption element 150 includes a planar electrode 151 arranged parallel to the ground electrode and a plurality of vias 152 electrically connecting the planar electrode 151 and the ground electrode GND. The planar electrode 151 has a substantially rectangular shape and has a first end portion 154 connected to the ground electrode GND with the vias 152 interposed therebetween and a second end portion 155 in an open state. As illustrated in FIGS. 10 and 11, the first end portion 154 and the second end portion 155 correspond to the sides of the planar electrode 151 along the X-axis direction. As illustrated in FIG. 11, a cross-section in the direction from the first end portion 154 toward the second end portion 155 has a substantially L shape. When the wave length of the radio waves radiated from the antenna elements 121 is represented by λ, the length of each current interruption element 150 in the Y-axis direction (that is, the length from the first end portions 154 to the second end portions 155) is set to approximately λ/4.

By configuring the current interruption elements 150 as described above, the current flowing through the ground electrode GND is canceled by interference at the open ends (second end portions 155) of the planar electrodes 151 facing the ground electrode GND, so that the current flowing through the ground electrode GND in the Y-axis direction can be interrupted. That is, the current interruption elements 150 exert the same effects as those by the conductor wall 125 along the X axis in Comparative Example 2 of Embodiment 1.

In the antenna module 100D according to Embodiment 3, the two current interruption elements 150 are arranged between the antenna elements 121, and the two current interruption elements 150 are arranged, such that the open ends (second end portions 155) of the planar electrodes 151 face each other. The two open ends of the two current interruption elements 150, which face each other, are partially electrically connected to each other with an electrode 153 interposed therebetween. A capacitance component is generated between the open ends by making the open ends of the two current interruption elements face each other as described above, and an inductive component is generated by electrically coupling a part of them. This can achieve resonance in two resonant modes of an odd mode and an even mode, and thus a current interruption effect can be realized in a wider frequency band.

It is optional to partially connect the two open ends of the two current interruption elements 150, which face each other. For example, when the dielectric constant of the dielectric substrate 130 is different, the two current interruption elements 150 resonate in the two resonant modes even when the two open ends are not connected in some cases.

As described above, by arranging at least one current interruption element between the antenna elements adjacent in the Y-axis direction in addition to the conductor wall along the Y-axis direction, it is possible to adjust the distribution of the current flowing through the ground electrode. Accordingly, isolation between the antenna elements can be enhanced, and decrease in the antenna gain when the radiation direction of the radio waves is inclined can be suppressed.

In Embodiment 3, the example of the configuration in which the parasitic elements are provided has been described. However, the current interruption elements may be arranged in the configuration in which no parasitic element is provided as in Embodiment 1. Alternatively, the antenna module may have the configuration in which one current interruption element is arranged between the antenna elements.

[Variation]

In the above-described embodiments, the configuration has been described in which the radio frequency signals are supplied to the respective antenna elements included in the antenna array by using the individual feed wirings. In a variation, the configuration in which the above-described conductor wall is formed in the configuration of an antenna module that supplies radio frequency signals to a plurality of antenna elements by one feed wiring will be described.

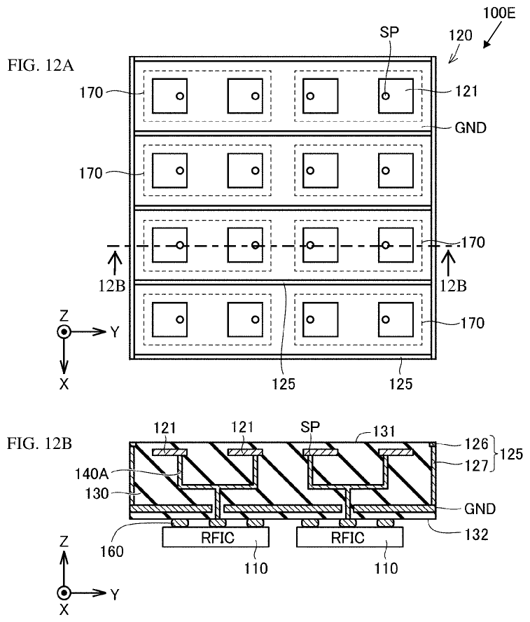

FIG. 12A is a plan view and FIG. 12B is a cross-sectional view of an antenna module 100E according to the variation. In the antenna module 100E, similarly to the antenna module 100 of FIGS. 2A and 2B described in Embodiment 1, the plurality of antenna elements 121 is arranged in an array form along the X-axis direction (first direction) and the Y-axis direction (second direction) on the inner layer of the rectangular dielectric substrate 130 or the surface 131 thereof on the upper surface side. The conductor wall 125 is formed so as to surround the entirety of the plurality of antenna elements 121 and is further formed along the Y-axis direction (polarization direction) between the antenna elements adjacent in the X-axis direction.

In the antenna module 100E, as illustrated in the cross-sectional view of FIG. 12B, sub arrays 170 are formed by two antenna elements 121 adjacently arranged in the Y-axis direction. Radio frequency signals are supplied from the RFIC 110 to the antenna elements 121 included in each sub array 170 while passing through a common feed wiring 140A. In other words, the feed wiring 140A connected to the RFIC 110 is branched into two directions on halfway and is connected to each of the two antenna elements 121 included in each sub array 170.

Even in the case where the antenna array is formed by the sub arrays each formed by the plurality of antenna elements, an antenna gain can be improved by forming the configuration in which the conductor wall extending in the polarization direction between the antenna elements adjacent in the direction orthogonal to the polarization direction is formed while no conductor wall between the antenna elements adjacent in the polarization direction is formed.

It should be considered that the embodiments disclosed herein are illustrative in all respects and are not limiting. The scope of the present disclosure is indicated by the scope of the claims rather than the description of the above-described embodiments, and it is intended to include all changes within the meaning and range equivalent to the scope of the claims.

### REFERENCE SIGNS LIST

10 COMMUNICATION APPARATUS
100, 100A to 100E ANTENNA MODULE
110 RFIC
111A to 111D, 113A to 113D, 117 SWITCH
112AR to 112DR LOW-NOISE AMPLIFIER
112AT to 112DT POWER AMPLIFIER
114A to 114D ATTENUATOR
115A to 115D PHASE SHIFTER
116 SIGNAL MULTIPLEXER/DEMULTIPLEXER
118 MIXER
119 AMPLIFICATION CIRCUIT
120 ANTENNA DEVICE
121 ANTENNA ELEMENT
122 PARASITIC ELEMENT
125, 125A CONDUCTOR WALL
126 WIRING PATTERN
127, 152 VIA
130 DIELECTRIC SUBSTRATE
131 SURFACE
132 BACK SURFACE
140, 140A FEED WIRING
150 CURRENT INTERRUPTION ELEMENT
151 PLANAR ELECTRODE
153 ELECTRODE
154 FIRST END PORTION
155 SECOND END PORTION
160 SOLDER BUMP
170 SUB ARRAY
200 BBIC
GND GROUND ELECTRODE
SP FEED POINT

1. An antenna module comprising:
a dielectric substrate;
a plurality of antenna elements in an array in the dielectric substrate, the array extending in a first direction and a second direction;
a ground electrode facing the plurality of antenna elements in the dielectric substrate; and
a conductor wall extending along the second direction between antenna elements that are adjacent to each other in the first direction, for each antenna element of the plurality of antenna elements, wherein:
the second direction is a polarization direction of a radio wave radiated from each of the plurality of antenna elements, and
the conductor wall is not between antenna elements that are adjacent to each other in the second direction.

2. The antenna module according to claim 1, wherein each of the plurality of antenna elements is a patch antenna.

3. The antenna module according to claim 1, wherein the first direction and the second direction are orthogonal to each other.

4. The antenna module according to claim 3, wherein the plurality of antenna elements is arranged linearly in the first direction and the second direction.

5. The antenna module according to claim 3, wherein the plurality of antenna elements is arranged linearly in the first direction and staggered in the second direction.

6. The antenna module according to claim 1, wherein the conductor wall comprises:
a plurality of vias connected to the ground electrode; and
a linear wiring pattern that connects the plurality of vias.

7. The antenna module according to claim 1, further comprising:
at least one current interruption circuit element between each pair of antenna elements that are adjacent in the second direction,
the at least one current interruption circuit element is electrically connected to the ground electrode and is configured to interrupt a current flowing through the ground electrode,
the at least one current interruption circuit element comprises a planar electrode that is parallel to the ground electrode, and has a first end portion electrically connected to the ground electrode and a second end portion in an open state, and
a length from the first end portion to the second end portion of the at least one current interruption circuit element is approximately λ/4, λ being a wavelength of the radio wave radiated from each of the plurality of antenna elements.

8. The antenna module according to claim 7, wherein:
the at least one current interruption circuit element comprises a first current interruption circuit element and a second current interruption circuit element, and
a second end portion of the first current interruption circuit element and a second end portion of the second current interruption circuit element face each other.

9. The antenna module according to claim 8, wherein the second end portion of the first current interruption circuit element and the second end portion of the second current interruption circuit element are partially electrically connected to each other.

10. The antenna module according to claim 7, further comprising a parasitic circuit element corresponding to each of the plurality of antenna elements,
wherein each of the plurality of antenna elements is between the corresponding parasitic element and the ground electrode.

11. The antenna module according to claim 1, further comprising a feed circuit configured to supply radio frequency signals to the plurality of antenna elements.

12. A communication apparatus comprising the antenna module according to claim 1.
